(19) United States
(12) Patent Application Publication
(10) Pub. No.: US 2010/0324866 A1
(43) Pub. Date: Dec. 23, 2010

(54) TESTING SYSTEM AND METHOD FOR VIDEO CHIP

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/512,043

(22) Filed: Jul. 30, 2009

(30) Foreign Application Priority Data
Jun. 17, 2009 (CN) 200910303327.5

(51) Int. Cl. G06F 15/00

(52) U.S. Cl. 702/186

(57) ABSTRACT

A testing system for a video chip to be tested stores a video file in advance. The testing system uses a sample video chip to play all frames of the video file and outputs first video data. A video chip to be tested is installed into the testing system to play a plurality of determined frames of the video file and outputs second video data. The first video data of corresponding frames and the second video data are compared to determine whether the video chip to be tested is acceptable or not, and a control signal is outputted according to the comparison to control a robotic arm to place the video chip to be tested at a determined place.

### BACKGROUND

1. Technical Field

The present disclosure relates to testing systems and methods, and particularly to a testing system and a testing method for a video chip.

2. Description of Related Art

In a conventional testing system for a video chip, the video chip to be tested is installed in a media player to play a video file stored in a disk, to check whether the video chip functions properly or not. However, the media player must be stopped when another video chip to be tested is being installed into the media player, and then started again. Repeated stopping and restarting the media player is time-consuming.

### BRIEF DESCRIPTION OF THE DRAWINGS

FIG. 1 is a block diagram of a first exemplary embodiment of a testing system for a video chip.

FIG. 2A and FIG. 2B is a flowchart of an exemplary embodiment of a testing method for a video chip.

FIG. 3 is a block diagram of a second exemplary embodiment of a testing system for a video chip.

### DETAILED DESCRIPTION

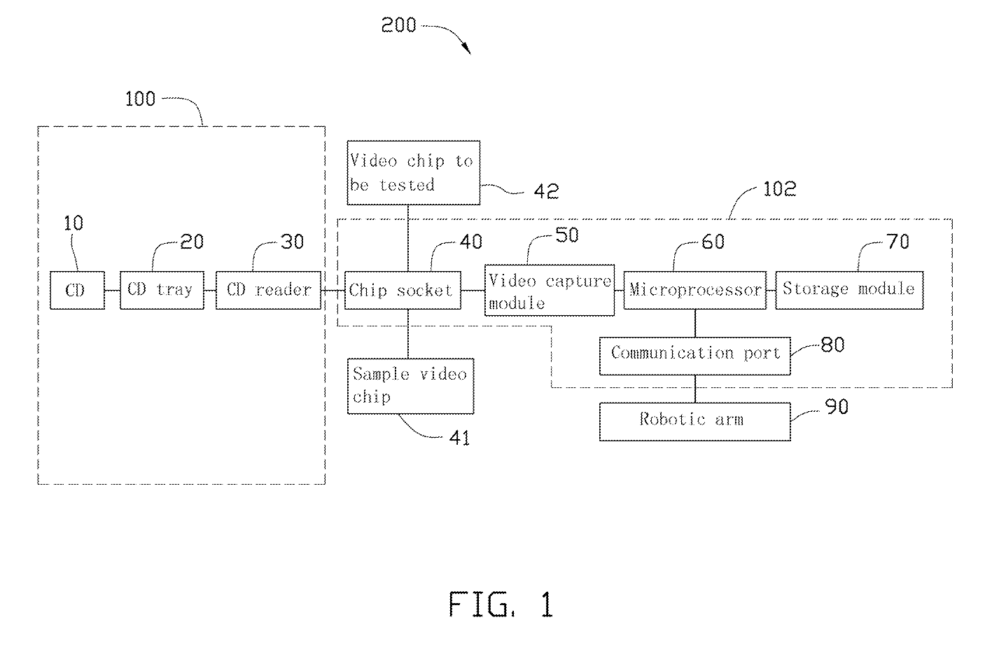

Referring to FIG. 1, a first exemplary embodiment of a testing system 200 for a video chip 42 includes a compact disc (CD) 10, a CD tray 20, a CD reader 30, a chip socket 40, a video capture module 50, a microprocessor 60, a storage module 70, a communication port 80, and a robotic arm 90.

The CD reader 30, the chip socket 40, the video capture module 50, the microprocessor 60, the communication port 80, and the robotic arm 90 are connected in series. The storage module 70 is connected to the microprocessor 60. In one exemplary embodiment, the compact disc (CD) 10, the CD tray 20, and the CD reader 30 may be installed in a media player 100. The chip socket 40, the video capture module 50, the microprocessor 60, the storage module 70, and the communication port 80 may be installed on a computer motherboard 102. In another exemplary embodiment, the chip socket 40 also may be defined in the media player 100.

In use, a video file is stored in the CD 10. The CD 10 is placed on the CD tray 20. The CD reader 30 reads the CD 10. A video chip conforming to requirements and functioning as a sample video chip 42 is installed to the chip socket 40 by the robotic arm 90, to play all frames of the video file stored in the CD 10. A first video signal output from the sample video chip 41 is transmitted to the video capture module 50 via the chip socket 40.

The video capture module 50 captures first video data of the first video signal, such as audio frequencies, video resolution, and so on. The first video data includes video data of every frame of the video file played by the sample video chip 41. For example, video data of a first frame of the video file includes an audio frequency as 192 kbps and video resolution as 1280*1024, video data of a second frame of the video file includes an audio frequency as 128 kbps and video resolution as 1024*768, and so on. Therefore, the first video data includes a plurality of video data groups, and one video data group is corresponding to one frame of the video file played by the sample video chip 41. The first video data are transmitted to the microprocessor 60, and stored in the storage module 70.

The CD reader 30 is stopped and the robotic arm 90 replaces the sample video chip 41 installed in the chip socket 20 with a first video chip 42 to be tested. The CD reader 30 reads the CD 10, and the first video chip 42 to be tested plays one hundred frames of the video file stored in the CD 10. A second video signal output from the first video chip 42 to be tested is transmitted to the video capture module 50 via the chip socket 40. The video capture module 50 captures a second video data of the second video signal. The second video data includes one hundred video data groups corresponding to the one hundred frames of the video file played by the first video chip 42. The second video data are transmitted to the microprocessor 60 in a format same as that of the first video data.

The microprocessor 60 compares the second video data with the first video data from a first frame to one-hundredth frame stored in the storage module 70 and played by the sample video chip 41. When a difference between the second video data and the first video data of the corresponding frames exceeds a determined value, the first video chip 42 to be tested is determined to be unacceptable; thereby the microprocessor 60 outputs a first control signal via the communication port 80 to control the robotic arm 90 to place the first video chip 42 to be tested at a first determined place.

When the difference between the second video data and the first video data of the corresponding frames does not exceed the determined value, the first video chip 42 to be tested is determined to be acceptable, thereby the microprocessor 60 outputs a second control signal via the communication port 80 to control the robotic arm 90 to place the first video chip 42 to be tested at a second determined place.

At the end of testing the first video chip 42, the robotic arm 90 takes the first tested video chip 42 away from the chip socket 40, and installs a second video chip 42 to be tested in the chip socket 40 for a next test. However, before the second video chip 42 is installed into the chip socket 40, the CD reader 30 continues to read the CD 10. Therefore, the video file stored in the CD 10 is played to the one hundred and tenth frame while the second video chip 42 is installed into the chip socket 40 to play the video file in the CD 10. That is to say, the second video chip 42 to be tested plays the video file in the CD 10 from the one-hundred and eleventh frame to the two-hundred and tenth frame of the video file in the CD 10. A third video signal output from the second video chip 42 to be tested is transmitted to the video capture module 50. The video capture module 50 captures third video data, which includes one hundred video data groups from the one-hundred and eleventh frame to the two-hundred and tenth frame of the video file played by the second video chip 42, and transmits the third video data to the microprocessor 60.

The microprocessor 60 compares the third video data with the first video data from the one-hundred and eleventh frame to the two-hundred and tenth frame in the storage module 70 and played by the sample video chip 41. When a difference between the third video data and the first video data of the corresponding frames exceeds the determined value, the second video chip 42 to be tested is determined to be unacceptable; thereby the microprocessor 60 outputs the first control signal via the communication port 80 to control the robotic arm 90 to place the second video chip 42 to be tested at the first determined place.

When the difference between the third video data and the first video data of the corresponding frames does not exceed the determined value, the second video chip 42 to be tested is determined to be acceptable, thereby the microprocessor 60 outputs the second control signal via the communication port 80 to control the robotic arm 90 to place the video chip 42 to be tested at the second determined place.

In the testing system 200 above-mentioned, the video chip 42 to be tested is hot plugged into the chip socket 40. Video data of a plurality of frames played by the video chip 42 to be tested are compared with the first video data of the corresponding frames played by the sample video chip 41, to determine whether the video chip 42 to be tested is acceptable, thereby the testing system 200 does not need to be stopped and restarted for each video chip 42 to be tested.

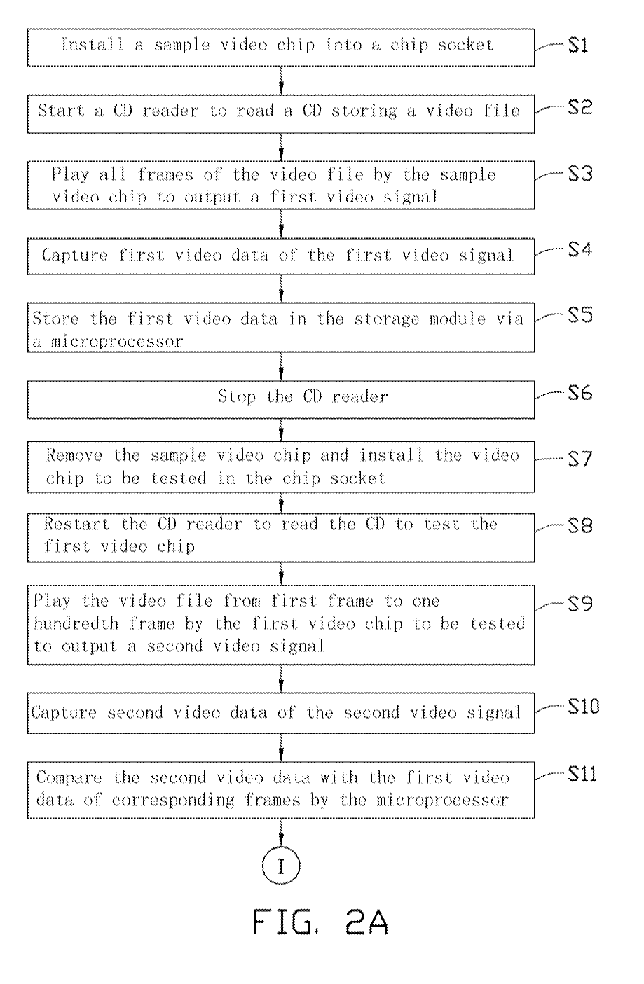

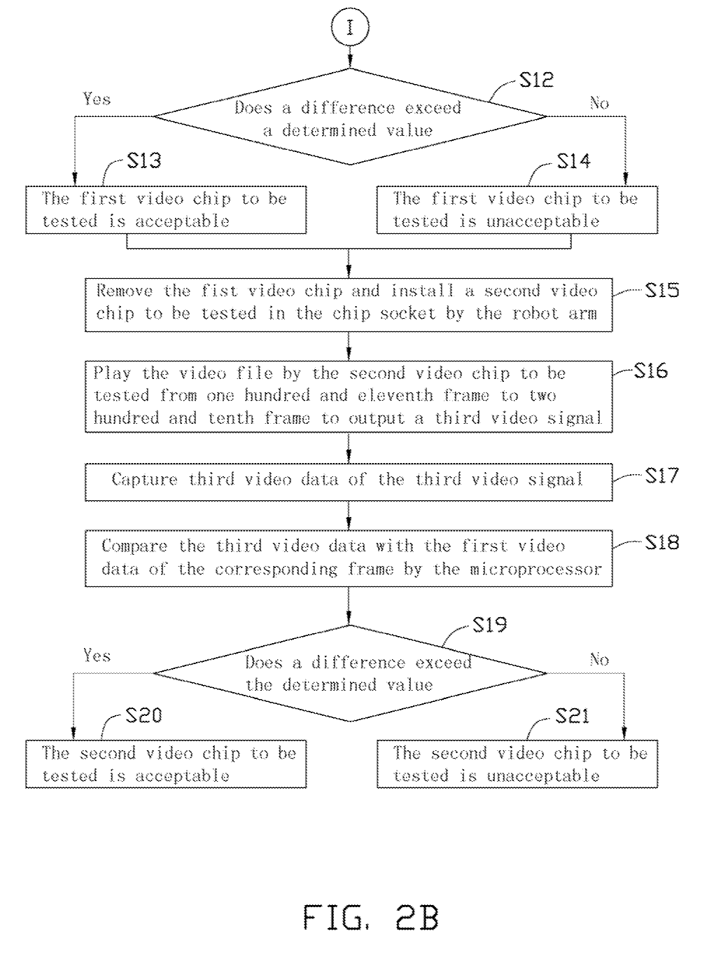

Referring to FIG. 2A and FIG. 2B, a testing method for a video chip employed by the system 200 includes the following steps.

In step S1, an acceptable video chip functioning as a sample video chip 41 is installed to the chip socket 40.

In step S2, the CD 10 storing a video file is placed on the CD tray 20, and the CD reader 30 is started to read the CD 10.

In step S3, The sample video chip 41 plays all frames of the video file and outputs a first video signal.

In step S4, the video capture module 50 captures first video data including video data of all frames from the first video signal and transmits the first video data to the microprocessor 60.

In step S5, the microprocessor 60 stores the first video data in the storage module 70.

In step S6, the CD reader 30 is stopped.

In step S7, the sample video chip 42 is removed from the chip socket 40 and the first video chip 42 to be tested is installed in the chip socket 40.

In step S8, the CD reader 30 is restarted to read the CD 10 to begin a test of the first video chip 42.

In step S9, the first video chip 42 to be tested plays the video file in CD 10 from a first frame to a one hundredth frame of all the frames and outputs a second video signal.

In step S10, the video capture module 50 captures second video data including video data of one hundred frames of the video file and transmits the second video data to the microprocessor 60.

In step S11, the microprocessor 60 compares the second video data with the first video data of the corresponding frames from the storage module 70.

In step S12, a determination is made whether a difference between the second video data and the first video data of corresponding frames exceeds a determined value or not. If the difference exceeds the determined value, the flow goes to step S13. If the difference does not exceed the determined value, the flow goes to step S14.

In step S13, the microprocessor 60 determines the first video chip 42 to be tested is unacceptable and outputs a first control signal via the communication port 80 to control the robotic arm 90 to place the first video chip 42 at a first determined place, and the flow goes to step S15.

In step S14, the microprocessor 60 determines the video chip 42 to be tested is acceptable and outputs a second control signal via the communication port 80 to control the robotic arm 90 to place the first video chip 42 at a second determined place, and the flow goes to the step S15.

In step S15, the first video chip 42 is removed from the chip socket 40 by the robot arm 90 and a second video chip 42 to be tested is installed in the chip socket 40.

In step S16, the second video chip 42 to be tested plays the video file in CD 10 from one hundred and eleventh frame to two hundred and tenth frame of the video file, and outputs a third video signal.

In step S17, the video capture module 50 captures third video data of the third video signal and transmits the third video data to the microprocessor 60.

In step S18, the microprocessor 60 compares the third video data with the first video data of the corresponding frames from the storage module 70.

In step S19, a determination is made whether a difference between the third video data and the first video data of corresponding frames exceeds the determined value or not. If the difference exceeds the determined value, the flow goes to step S20. If the difference does not exceed the determined value, the flow goes to step S21.

In step S20, the microprocessor 60 determines the second video chip 42 to be tested is unacceptable and outputs the first control signal via the communication port 80 to control the robotic arm 90 to place the second video chip 42 at the first determined place.

In step S21, the microprocessor 60 determines the second video chip 42 to be tested is acceptable and outputs the second control signal via the communication port 80 to control the robotic arm 90 to place the second video chip 42 at the second determined place.

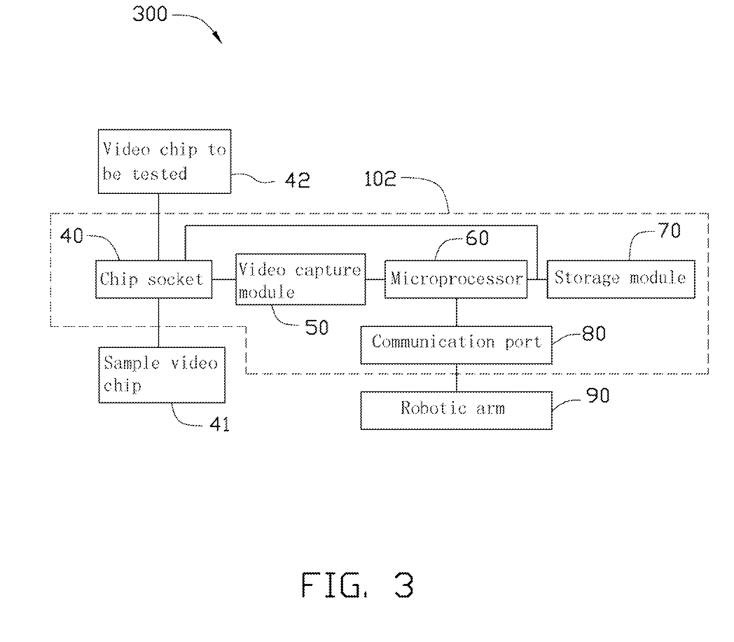

Referring to FIG. 3, a second exemplary embodiment of a testing system 300 for a video chip 42 includes a chip socket 40, a video capture module 50, a microprocessor 60, a storage module 70, a communication port 80, and a robot arm 90, which are same as those in the first exemplary embodiment. The video file is stored in the storage module 70, not the CD 10, therefore, the sample video chip 41 or the video chip 42 to be tested directly plays the video file in the storage module 70, and the testing system 300 does not need to be stopped and restarted when another video chip 42 needs to be tested.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A testing system for a video chip, comprising:
a video file;
a chip socket to install a sample video chip or a video chip to be tested; wherein the sample video chip plays all frames of the video file and outputs a first video signal in response to the sample video chip being installed to the chip socket, and the video chip to be tested plays a plurality of determined frames of the video file and outputs a second video signal in response to the video chip to be tested being installed to the chip socket;
a video capture module to capture first video data of the first video signal and second video data of the second video signal; and
a microprocessor to receive the first video data and store the first video data in a storage module, and to receive and compare the second video data with the first video data of corresponding frames from the storage module, to determine whether the video chip to be tested is acceptable or not.

2. The testing system of claim 1, wherein the video file is stored in a compact disk (CD); the testing system further comprises a CD tray and a CD reader, the CD is placed on the CD tray, and the CD reader is used to read the CD and transmit data to the sample video chip or the video chip to be tested.

3. The testing system of claim 2, wherein the CD, the CD tray, and the CD reader are installed in a media player.

4. The testing system of claim 1, wherein the video file is stored in the storage module.

5. The testing system of claim 1, wherein the chip socket, the storage module, the video capture module, and the microprocessor are installed on a computer motherboard.

6. The testing system of claim 1, further comprises a robotic arm, wherein the microprocessor is operable to output a control signal to control the robotic arm to place the tested video chip at a determined place after comparing the first video data of corresponding frames and the second video data.

7. The testing system of claim 1, wherein the first video data and the second video data both comprise audio frequencies and video resolutions.

8. A testing method for a video chip, comprising:
storing a video file;
installing a sample video chip to a chip socket;
playing all frames of the video file via the sample video chip to output a first video signal;
capturing first video data of the first video signal via a video capture module and transmitting the first video data to a microprocessor;
storing the first video data in a storage module via the microprocessor;
removing the sample video chip from the chip socket and installing a video chip to be tested to the chip socket;
playing a plurality of determined frames of the video file via the video chip to be tested to output a second video signal;
capturing second video data of the second video signal via the video capture module and transmitting the second video data to the microprocessor; and
comparing the second video data with the first data of corresponding frames from the storage module by the microprocessor, to determine whether the video chip to be tested is acceptable or not.

9. The testing method of claim 8, further comprising:
determining that the video chip is unacceptable in response to a difference between the second video data and the first video data of corresponding frames exceeding a determined value; and
determining that the video chip to be tested is acceptable in response to the difference between the second video data and the first video data of corresponding frames not exceeding the determined value.

10. The testing method of claim 9, further comprising:
outputting a first control signal to control a robotic arm to place the tested video chip at a first determined place, in response to the video chip to be tested being determined to be unacceptable.

11. The testing method of claim 10, further comprising:
outputting a second control signal to control a robotic arm to place the tested video chip at a second determined place in response to the video chip to be tested being determined to be acceptable.

12. The testing method of claim 8, wherein the video file is stored in a compact disk (CD), the CD is placed on a CD tray, and a CD reader is used to read the CD and transmit data to the sample video chip or the video chip to be tested.

13. The testing method of claim 12, wherein the CD, the CD tray, the CD reader are installed in a media player.

14. The testing method of claim 8, wherein the video file is stored in the storage module.

15. The testing method of claim 8, wherein the chip socket, the storage module, the video capture module, and the microprocessor are installed on a computer motherboard.

16. The testing method of claim 8, wherein the first video data and the second video data both comprise audio frequencies and video resolutions.
